(19) United States
(12) Patent Application Publication
(10) Pub. No.: US 2023/0409970 A1
(43) Pub. Date: Dec. 21, 2023

(54) METHOD AND SYSTEM FOR DETERMINING EVENT OCCURRENCE BASED ON DATA SIGNALS

(71) Applicant: RAJIV TREHAN, BANGKOK (TH)

(72) Inventor: RAJIV TREHAN, BANGKOK (TH)

(21) Appl. No.: 18/210,094

(22) Filed: Jun. 15, 2023

Related U.S. Application Data
(60) Provisional application No. 63/352,693, filed on Jun. 16, 2022.

(51) Int. Cl. G06N 20/00

(52) U.S. Cl. CPC G06N 20/00

(57) ABSTRACT

A method and system for determining occurrence of events based on data signals is disclosed. The method includes receiving a plurality of data signals associated with an entity from a plurality of data sources. The method includes deriving one or more data signals from the plurality of data signals. Each of the one or more derived data signals includes an associated time dimension. The method includes identifying a pattern associated with the entity within the one or more derived data signals and the plurality of data signals. The pattern corresponds to occurrence of two or more data signals within an overlap in the time dimensions associated with the two or more data signals. The method includes determining occurrence of an event associated with the entity within a predefined time period, based on the identified pattern and the overlap in the time dimensions associated with the two or more data signals.

### TECHNICAL FIELD

The present disclosure relates to Artificial Intelligence (AI), and more particularly to a method and system for determining occurrence of events based on data signals.

### BACKGROUND

From the times when digital exchange of company shares, goods and services was initiated, many automated trading tools have been developed. These automated trading tools monitor information such as price, volume, and variations of a traded product, and accordingly, decisions regarding sell or purchase are made using a pre-defined algorithm. Moreover, many existing exchange-connected platforms allow and even encourage users to customize trade creation using built-in languages and macros. The quantitative analysis generated for trade products using these automated trading tools have provided massive profits to some people whereas for others it has been a reason for massive loss. In recent years, there has been a rising belief and attempt to use AI models to identify potential trades. These AI models are trained on past time-series data for a given trade product, sector, market, price point, volume, volatility with expectation of predicting future trade prices. Such AI models can also take inputs from a wide range of sources including news and blogs to add additional parameters to the training set of the AI models into the predictions. It should be noted that these AI models are only as good as the training data used for training these AI models to identify trends and predict similar outcomes for actual data based on these trends.

It is known that Machine Learning based AI is a process of defining a model of nodes and weights and then incrementally adjusting weights until the AI model learns to predict expected outcomes based on input training data. However, the training of the AI model is difficult and experimental as it requires large exemplary data sets that may match a final expected outcome. Often, these AI models appear to work well but have built-in overfit, under-fit, or bias that is a result of the training data. Moreover, if the training data for training the AI model is not large enough, bias, over fit, or under fit, then the AI model may generate erroneous trade outcomes. This particularly happens while dealing with unstructured data such as news and blogs.

In past years, the issues of erroneous trades generated due to the training data has been managed in several ways, such as, by limiting the degree to which the AI model may freely trade, having some expert overviews on trade and approval or rejection, building more complex AI models, customization of the AI models for each trade product or group of trade products, and the like. Further, it is highly desirable that recommendations have some level of understandability or are accompanied with an explanation of the basis for the recommendation. However, typically an AI model only provides a prediction without the ability to explain the reason for the basis of the recommendations to users. For automated systems this makes the decision process difficult to verify or have confidence in.

Therefore, there is a need for an efficient and robust technique for providing recommendation to users by determining occurrence of events based on data signals.

### SUMMARY

In an embodiment, a method for determining occurrence of events based on data signals is disclosed. In one embodiment, the method may include receiving a plurality of data signals associated with an entity from a plurality of data sources. It should be noted that the plurality of data signals may include structured data signals and unstructured data signals. The method may include deriving one or more data signals from the plurality of data signals via at least one of a pre-configured algorithm, a statistical analysis technique, or an Artificial Intelligence (AI) based analysis technique. It should be noted that each of the one or more data signals may include an associated time dimension. The method may include identifying, by a trained AI model, a pattern associated with the entity within the one or more derived data signals and the plurality of data signals. It should be noted that the pattern may correspond to occurrence of two or more data signals within an overlap in the time dimensions associated with the two or more data signals. The method may include determining, by the trained AI model, occurrence of an event associated with the entity within a predefined time period, based on the identified pattern and the overlap in the time dimensions associated with the two or more data signals.

In another embodiment, a method for training an Artificial Intelligence (AI) model for determining occurrence of events is disclosed. The method may include extracting a plurality of training data signals associated with at least one entity from a plurality of data sources. It should be noted that the plurality of training data signals may include structured training data signals and unstructured training data signals. Additionally, the plurality of training data signals may be extracted from the plurality of data sources for a pre-defined time-period. The method may include deriving one or more training data signals from the plurality of training data signals via at least one of a pre-configured algorithm, a statistical analysis technique, or an AI based analysis technique. It should be noted that each of the one or more training data signals may include an associated time dimension. The method may include converting each of the one or more derived training data signals and the associated time dimension into a set of training vectors. The method may include iteratively training the AI model based on the set of training vectors and the one or more derived training data signals for determining occurrence of one or more events for each of the plurality of training data signals.

In yet another embodiment, a system for determining occurrence of events based on data signals is disclosed. The system includes a processor and a memory communicatively coupled to the processor. The memory stores processor-executable instructions which on execution causes the processor to receive a plurality of data signals associated with an entity from a plurality of data sources. It should be noted that the plurality of data signals may include structured data signals and unstructured data signals. The processor-executable instructions, on execution, may further cause the processor to derive one or more data signals from the plurality of data signals via at least one of a pre-configured algorithm, a statistical analysis technique, or Artificial Intelligence (AI) based analysis technique. It should be noted that each of the one or more data signals may include an associated time dimension. The processor-executable instructions, on execution, may further cause the processor to identify, by a trained AI model, a pattern associated with the entity within the one or more derived data signals and the plurality of data signals. It should be noted that the pattern may correspond to occurrence of two or more data signals within an overlap in the time dimensions associated with the two or more data signals. The processor-executable instructions, on execution, may further cause the processor to determine, by the trained AI model, occurrence of an event associated with the entity within a predefined time period, based on the identified pattern and the overlap in the time dimensions associated with the two or more data signals.

In yet another embodiment, a system for training an Artificial Intelligence (AI) model for determining occurrence of events is disclosed. The system includes a processor and a memory communicatively coupled to the processor. The memory stores processor-executable instructions which on execution causes the processor to extract a plurality of training data signals associated with at least one entity from a plurality of data sources. It should be noted that the plurality of training data signals may include structured training data signals and unstructured training data signals. Additionally, the plurality of training data signals may be extracted from the plurality of data sources for a pre-defined time period. The memory stores processor-executable instructions which on execution causes the processor to derive one or more training data signals from the plurality of training data signals via at least one of a pre-configured algorithm, a statistical analysis technique, or an AI based analysis technique. It should be noted that each of the one or more training data signals comprises an associated time dimension. The memory stores processor-executable instructions which on execution causes the processor to convert each of the one or more derived training data signals and the associated time dimension into a set of training vectors. The memory stores processor-executable instructions which on execution causes the processor to iteratively train the AI model based on the set of training vectors and the one or more derived training data signals for determining occurrence of one or more events for each of the plurality of training data signals.

It is to be understood that both the foregoing general description and the following detailed description are exemplary and explanatory only and are not restrictive of the invention, as claimed.

### BRIEF DESCRIPTION OF THE DRAWINGS

The accompanying drawing, which are incorporated in and constitute a part of this disclosure, illustrate exemplary embodiments and, together with the description, explains the disclosed principles.

FIG. 1 is a block diagram illustrating a system for determining occurrence of events based on data signals, in accordance with some embodiments.

FIG. 2 illustrates a flowchart of a method for determining occurrence of events based on data signals, in accordance with some embodiments.

FIG. 3 illustrates a flowchart of a method of removing noisy data signals, in accordance with some embodiments.

FIG. 4 illustrates a flowchart of a method for identifying a pattern, in accordance with some embodiments.

FIG. 5 illustrates a flowchart of a method of selecting an event, in accordance with some embodiments.

FIG. 6 illustrates a flowchart of a method for rendering a set of actions to a user, in accordance with some embodiments.

FIG. 7 illustrates a flowchart of a method of training an AI model for determining occurrence of events, in accordance with some embodiments.

FIG. 8 illustrates a flowchart of a method for determining occurrence of one or more events, in accordance with some embodiments.

FIG. 9 illustrates a flowchart of a method of performing incremental training of an AI model, in accordance with some embodiments.

FIG. 10A-10D represent GUIs depicting determination of occurrence of an event associated with an entity, in accordance with an exemplary embodiment.

FIG. 11 is a block diagram of an exemplary computer system for implementing embodiments consistent with some exemplary embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

The following description is presented to enable a person of ordinary skill in the art to make and use the invention and is provided in the context of applications and their requirements. Various modifications to the embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and devices are shown in block diagram form in order not to obscure the encryption of the invention with unnecessary detail. Thus, the invention is not intended to be limited to the embodiments shown but is to be accorded the widest scope consistent with the principles and features disclosed herein.

While the invention is described in terms of particular examples and illustrative figures, those of ordinary skill in the art will recognize that the invention is not limited to the examples or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic and/or an appropriate combination thereof, as would be recognized by one skilled in the art to carry out the recited functions.) Software and firmware can be stored on computer-readable storage media. Some other processes can be implemented using analog circuitry, as is well known to one of ordinary skill in the art. Additionally, memory or other storage, as well as communication components, may be employed in embodiments of the invention.

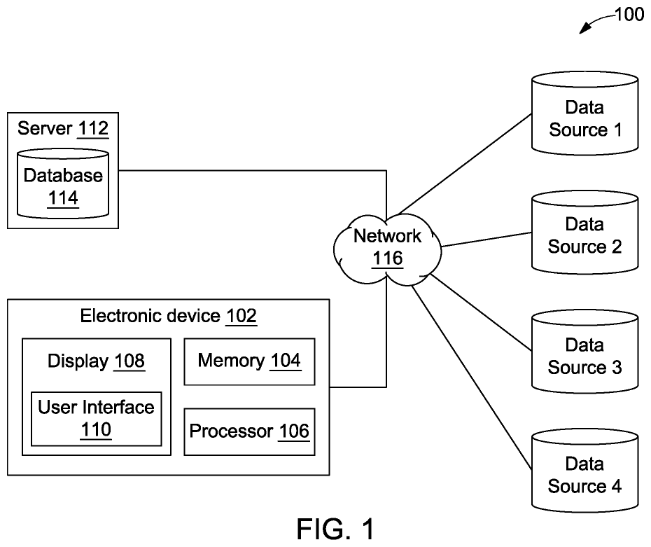

A system 100 for determining occurrence of events based on data signals is illustrated in FIG. 1. In particular, the system 100 may include an electronic device 102 that may be responsible for determining occurrence of events based on data signals. In order to determine the occurrence of an event, initially, the electronic device 102 may be configured to receive a plurality of data signals corresponding to an entity. By way of an example, each of the plurality of data signals received from the plurality of data sources may correspond to a trade signal. Further, the entity may correspond to an organization or a company that is involved in various sectors, such as, healthcare, materials, real estate, consumer staples, consumer discretionary, utilities, energy, industrials, consumer services, financials, and technology.

The electronic device 102 may receive the plurality of data signals from a plurality of data sources. As depicted via present FIG. 1, the plurality of data sources may correspond to a data source 1, a data source 2, a data source 3, and a data source 4. It should be noted that, for ease of representation, only four data sources are shown. However, the plurality of data signals may be received from any number of data sources. Further, when the plurality of data signals may correspond to the trade signals, then each of the trade signals may represent any information related to the entity that may impact stock of that entity. In case of the trade signals, examples of the plurality of data signals may include, but is not limited to, historical trade data such as time-series data, price point data, trade volume, trade volatility, trade product, trade sector, trade market, trade related news, trade related blogs. In addition, the plurality of data sources may include, but are not limited to, historical trade data sources, trade maps, trade trends, social media contents, and any other trade related data available in public and/or private domain.

Further, the plurality of data signals may include structured data signals and unstructured data signals. In other words, the plurality of data signals received for the entity may correspond to raw data signals fetched from the plurality of data sources. The raw data signals may include structured data signals and unstructured data signals. For example, for the trade signals, the structured data signals may correspond to data signals received from data sources, such as, monthly, quarterly, or yearly financial performance of the entity, Price to Earnings (P/E) ratio of the entity, performance on stock market for a given time period, any investment or acquisition made by the entity, or any funding received by the entity from a Venture Capitalist (VC) or an angel investor, and the like. Further, the unstructured data signals may correspond to data signals received from unstructured data sources, such as, news, blogs, social media posts about possibility of CEO resigning or being fired by board, hostile acquisition of the entity, negative or positive comments made by celebrities or social media influencers the entity, social media comments from consumers about entity's products/services losing its quality, or social media comments about bad employee management practices, and the like.

Upon receiving the plurality of data signals, the electronic device 102 may be configured to remove noisy data signals from the plurality of data signals. A method of removing the noisy data signals is further explained in detail in conjunction with FIG. 3. Once noisy data signals are removed, the electronic device 102 may be configured to derive one or more data signals from the plurality of data signals. The electronic device 102 may derive the one or more data signals via at least one of a pre-configured algorithm, a statistical analysis technique, or AI based analysis technique. In an embodiment, each of the one or more data signals may include an associated time dimension. In an embodiment, the associated time dimension may represent a time period for which each of the one or more data signals may be valid.

Once the one or more data signals are derived, the electronic device 102 may be configured to identify a pattern associated with the entity within the one or more derived data signals and the plurality of data signals. In an embodiment, the pattern may correspond to occurrence of two or more data signals within an overlap in the time dimensions associated with the two or more data signals. In other words, the pattern may correspond to a behavior of the stock associated with the entity over a period of time. The electronic device 102 may identify the pattern via a trained Artificial Intelligence (AI) model. In an embodiment, the trained AI model may reside within a memory 104 of the electronic device 102. In some another embodiment, the trained AI model may correspond to an application (e.g., a web application or a mobile application) installed within a user device. Examples of the electronic device 102 and the user device may include, but are not limited to, a server, a desktop, a laptop, a notebook, a tablet, a smart phone, a mobile phone, an application server, or the like.

Further, in some another embodiment, the trained AI model may be considered as a neural network model. The neural network model may be trained by adjusting weights to predict an accurate outcome using an optimization algorithm. Examples of the neural network model may include, but are not limited to, convolution neural network, recurrent neural network, Hopfield neural network, feedforward neural network, perceptron and multilayer perceptron neural networks, long short-term memory (LSTM) neural network, and modular neural network.

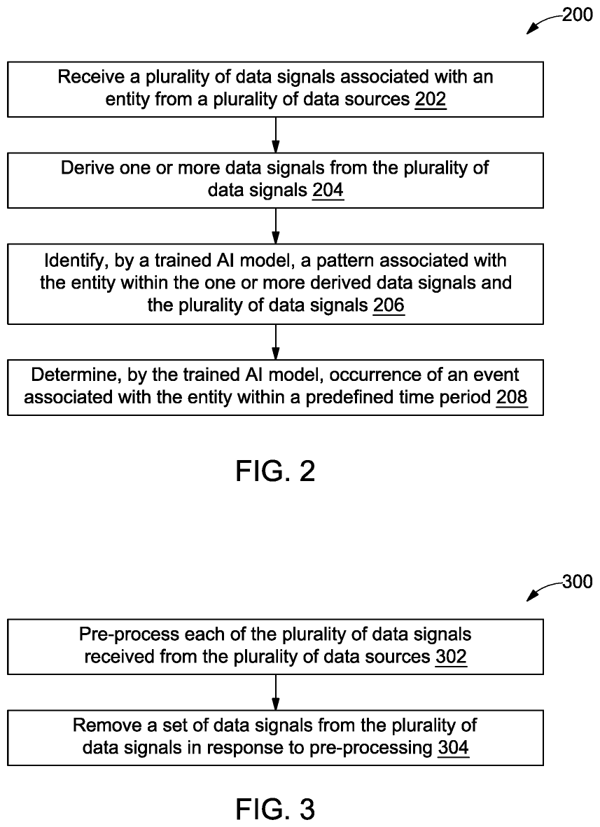

Once the pattern associated with the entity is identified, then the electronic device 102 may be configured to determine occurrence of the event associated with the entity within a predefined time period via the trained AI model. In an embodiment, when the plurality of data signals are the trade signals, then the event may correspond to a rise or a fall in a stock price of the entity. Further, the trained AI model may determine the rise and the fall of the stock price of the entity for the pre-defined time period, for example, 1 day, 1 week, 1 month, 6 months, and the like. The occurrence of the event may be determined based on the identified pattern and the overlap in the time dimensions associated with the two or more data signals. In order to determine the occurrence of the event, the trained AI model may determine a whether a relation exists between the two or more data signals from the one or more data signals based on a vector associated with each of the two or more data signals. In an embodiment, the relation may be determined based on at least one of a repeated occurrence of the two or more data signals over a period of time, a magnitude of an analogous pattern associated with two or more former data signals, and a weight associated the analogous pattern. A method of determining the occurrence of the event associated with the entity has been further explained in detail in conjunction with FIGS. 2-5.

Once the occurrence of the event is determined, the electronic device 102 may be configured to generate a set of user actions based on the determined event. In continuation to above example, when each of the plurality of data signals may correspond to the trade signal, then the set of user actions may correspond to a recommendation, such as, a recommendation to buy the stock of the entity, a recommendation to sell the stock of the entity, a recommendation to hold a sell of previously purchased stock, and the like. Further, the electronic device 102 may be configured to render each of the set of user actions to a user (e.g., a trader).

As will be appreciated, the set of user actions may be generated by an AI model (e.g., a generative AI model). The generative AI model may reside within the memory 104 of the electronic device 102. It should be noted that, in some embodiment, the generative AI model may be different from the trained AI model. Further, in some another embodiment, the generative AI model may be same as the trained AI model. As will be appreciated, in order to determine the occurrence of the event, the trained AI model may be initially trained based on a plurality of set of training data signals associated with a plurality of entities. A method of training the AI model is further explained in detail in conjunction with FIGS. 7-9.

In addition to the memory 104, the electronic device 102 may further include a processor 106, and a display 108. The display 108 may further include a user interface 110. In some embodiment, the user interface 110 may be a Graphical User Interface (GUI), or other forms, such as, in a form of message alerts, or an intelligent assistant, a remote terminal (i.e., user's smart phone), Further, in addition to intelligent assistant, messaging or smartphone may be an input terminal for the user. The user may interact with the electronic device 102 and vice versa through the display 108. By way of an example, the display 108 may be used to display results, such the identified pattern, the occurred event, the set of user actions, and the like, based on actions performed by the electronic device 102, to the user. Moreover, the display 108 may be used to display the recommendation generated based on the determined occurrence of the event, to the user.

By way of another example, the user interface 110 may be used by the user to provide inputs to the electronic device 102. Thus, for example, in some embodiment, the user may provide an input via the electronic device 102 that includes a name of the entity of which the user may be interested in buying the stock, a date for analysis of stock price of the entity and the like. Further, for example, in some embodiments, the electronic device 102 may render intermediate results which may include the plurality of data signals, the plurality of data signals generated after pre-processing, the one or more derived data signals, the relation between the one or more data signals, and the like, or the final results including the occurrence of the event, the set of user actions, and the like, to the user via user interfaces 110 or a user interface of the user device.

The memory 104 may store instructions that, when executed by the processor 106, may cause the processor 106 to determine the occurrence of the event based on the plurality of data signals received from the plurality of sources. As will be described in greater detail in conjunction with FIG. 2 to FIG. 10, in order to determine the occurrence of the event, the processor 106 in conjunction with the memory 104 may perform various functions including deriving the one or more data signals, identifying the pattern associated with the entity within the one or more derived data signals, determining occurrence of the event associated with the entity, determining whether the relation exists between the two or more data signals from the one or more data signals, etc.

The memory 104 may also store various data such as the plurality of data signals, results of pre-processing of each of the plurality of data signals, the one or more derived data signals, the relation determined between the two or more data signals, the occurred event, the set of user actions, and the like, that may be captured, processed, and/or required by the electronic device 102. The memory 106 may be a non-volatile memory which may include, but not limited to a flash memory, Read Only Memory (ROM), Programmable ROM (PROM), Erasable PROM (EPROM), Electrically EPROM (EEPROM) memory, etc.) or a volatile memory (e.g., Dynamic Random-Access Memory (DRAM), Static Random-Access memory (SRAM), and the like.

Further, the electronic device 102 may interact with a server 112 and the plurality of data sources over a network 116 for sending and receiving various data. The network 116, for example, may be any wired or wireless communication network and the examples may include, but may be not limited to, the Internet, Wireless Local Area Network (WLAN), Wi-Fi, Long Term Evolution (LTE), Worldwide Interoperability for Microwave Access (WiMAX), and General Packet Radio Service (GPRS).

In some embodiments, the electronic device 102 may extract the plurality of data signals from the server 112. By way of an example, the server 112 may provide access to trade related information available on the plurality of data sources. The server 112 may further include a database 114. The database 114 may store information (data signals) associated with the plurality of entities. The database 114 may be periodically updated with new information (new data signals) available for each of the plurality of entities. In addition, the database 118 may be updated with a new entity and a plurality of data signals associated with the new entity.

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

Referring now to FIG. 2, a flowchart of a method 200 for determining occurrence of events based on data signals is illustrated, in accordance with some embodiments. In order to determine the occurrence of the event, initially at step 202, a plurality of data signals may be received from a plurality of data sources. The plurality of data signals may be associated with an entity (e.g., a company or an organization). In case when the plurality of data signals corresponds to trade signals, then examples of the plurality of data signals may include, but is not limited to, historical trade data such as time-series data, price point data, trade volume, trade volatility, trade product, trade sector, trade market, trade related news, trade related blogs. In addition, the plurality of data sources may include, but are not limited to, historical trade data sources, trade maps, trade trends, social media contents, and any other trade related data available in public and/or private domain. Once the plurality of data signals is received, the noisy data signals may be removed from the plurality of data signals. A method of removing the noisy data signals has been further explained in detail in conjunction with FIG. 3.

In an embodiment, the plurality of data signals may include structured data signals and unstructured data signals. By way of an example, when the plurality of data signals are the trade signals, then the structured data signals for the entity may include, for example, monthly, quarterly, or yearly financial performance of the company, P/E ratio of the entity, performance on stock market for a given time period, any investment or acquisition made by the entity, or any funding received by the entity from a Venture Capitalist (VC) or an angel investor, and the like. In a similar manner, the unstructured data signals, for example, may include news or social media posts about possibility of CEO resigning or being fired by board, hostile acquisition of the entity, negative or positive comments made by celebrities or social media influencers about the entity, social media comments from consumers about entity's products/services losing its quality, or social media comments about bad employee management practices, and the like.

By way of an example, one such structured trade signal extracted for an entity (for example, SNAPCHAT), may be stock price of the entity SNAPCHAT on New York Stock Exchange (NYSE) for a given time period. By way of another example, one such un-structured trade signal extracted for same entity, i.e., the SNAPCHAT may be a statement made by a Hollywood Superstar on her INSTAGRAM account, i.e., “SNAPCHAT is not my fav app anymore”. Upon receiving the plurality of data signals, at step 204, one or more data signals may be derived from the plurality of data signals. The one or more data signals may be derived via at least one of a pre-configured algorithm, a statistical analysis technique, or an AI based analysis technique. In an embodiment, each of the one or more data signals may include an associated time dimension. In an embodiment, the associated time dimension may represent a time period for which each of the one or more data signals may be valid.

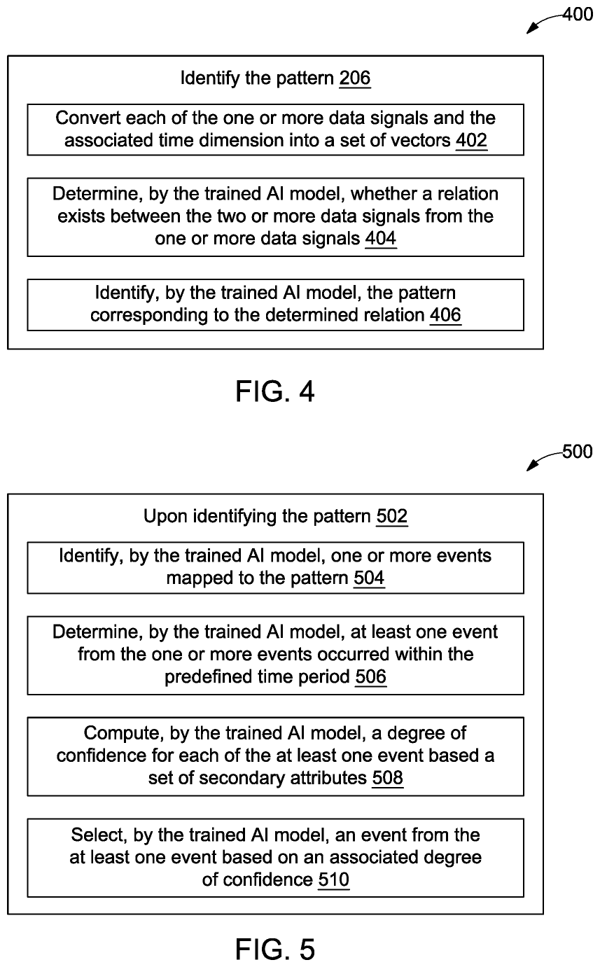

Once the one or more data signals are derived from the plurality of data signals, then at step 206, a pattern associated with the entity may be identified. In an embodiment, the pattern may be identified within the one or more derived data signals and the plurality of data signals. The pattern may correspond to occurrence of two or more data signals within an overlap in the time dimensions associated with the two or more data signals. In other words, the pattern may correspond to a behavior of the stock associated with the entity over a period of time. A method of identifying the pattern has been further explained in detail in conjunction with FIGS. 4-5. Further, upon identifying the pattern, at step 208, occurrence of the event associated with the entity may be determined. In an embodiment, the occurrence of the event may be determined within a predefined time period. Moreover, the occurrence of the event may be determined based on the identified pattern and the overlap in the time dimensions associated with the two or more data signals. By way of an example, when the plurality of data signals are the trade signals, then the event may correspond to a rise or a fall in a stock price of the entity. Further, the trained AI model may determine the rise and the fall of the stock price of the entity for the pre-defined time period, for example, 1 day, 1 week, 1 month, 6 months, and the like.

By way of an example, consider a user, e.g., a trader may be interested in knowing the occurrence of the event corresponding to an entity XYZ in the near future, for e.g., 1 week. With reference to FIG. 1, in order to know about the occurrence of the event, the user may use the electronic device 102. In particular, the user may login to an application installed in the electronic device 102 using his login credentials. In this case, when the user is interested in knowing the occurrence of the event for the entity XYZ, then initially, the electronic device 102 may receive the trade signals corresponding to the entity XYZ from the plurality of data sources. Upon receiving the trade signals, the electronic device 102 may derive the one or more trade signals from the trade signals. Once the one or more signals are derived, then the electronic device 102 may identify a pattern associated with the entity XYZ using the trained AI model. Once the pattern is identified, the AI model may determine the occurrence of the event corresponding to the entity within 1 week. In particular, the AI model may determine the rise or the fall in the stock price of the entity XYZ within 1 week.

Referring now to FIG. 3, a flowchart of a method 300 for removing noisy data signals is illustrated, in accordance with some embodiments. With reference to FIG. 2, upon receiving the plurality of data signals as mentioned via step 202, at step 302, each of the plurality of data signals may be pre-processed based on pre-defined criteria. As will be appreciated, the pre-processing of each of the plurality of data signals may be done to remove data signals from the plurality of data signals that contribute to noise. In an embodiment, the pre-defined criteria may include, but are not limited to, a time, a location, a time zone, a market trend, statistics, people with specific profiles, interest rates, employment rate, regional conflicts, and the like.

In other words, the pre-defined criteria may be indicative of relevancy or impact of each of the plurality of data signals on the entity. Further, based on the pre-processing, at step 304, a set of data signals may be removed from the plurality of data signals in response to pre-processing. In an embodiment, each of the set of data signals may correspond to a noisy data signal. Once each of the set of data signals identified as the noise data signals are removed, then remaining data signals within the plurality of data signals may be considered as relevant data signals.

By way of an example, when other SNAPCHAT users (not as famous as the Hollywood superstar) may also have made similar comments about SNAPCHAT or any other entity for that matter, then such trade signals may be considered as the noise data signals. This is because the comments made by these anonymous or ordinary users may have minimal impact on usage of the SNAPCHAT, which in turn may have no significant impact on the stock price of the SNAPCHAT. In an exemplary scenario, such a data signal may be considered as noise, if the number of followers for the source user of this data signal is below a certain number. In continuation of the above example, for the entity SNAPCHAT, following data signals may be selected as relevant: INSTAGRAM comment from the Hollywood Superstar, i.e., “SNAPCHAT is not my fav app anymore,” stock price of SNAPCHAT at the NYSE for the given time period, new on any acquisition made by SNAPCHAT, news about funding received by SNAPCHAT, or news about SNAPCHAT laying off people.

Referring now to FIG. 4, a flowchart of a method 400 for identifying a pattern is illustrated, in accordance with some embodiments. With reference to FIG. 2, as mentioned via step 206, in order to identify the pattern, at step 402, each of the one or more data signals and the associated time dimension may be converted into a set of vectors. By way of an example, when each of the plurality of data signals represents the trade signals, then the set of feature vectors may correspond to a set of trade feature vectors. The set of trade feature vectors may be generated by converting the trade signals and the time dimension associated with each of the trade signals into the set of trade feature vectors.

Further, at step 404, a check may be performed to determine whether a relation exists between the two or more data signals from the one or more data signals. The determination of whether the relation exists between the two or more data signals may be done based on a vector associated with each of the two or more data signals. In particular, the relation may be determined based on at least one of a repeated occurrence of the two or more data signals over a period of time, a magnitude of an analogous pattern associated with two or more former data signals, and a weight associated the analogous pattern.

By way of another example, consider where the two or more data signals associated with the entity may include a first data signal indicating a loss in balance sheet of the entity, and a second data signal indicating some news regarding layoffs of its employees. Further, based on the check performed, the relation may be determined to be existing between these two data signals. In other words, the first data signal may have caused the second data signals to occur. Upon determining the relation, at step 406, the pattern corresponding to the determined relation may be identified. In continuation to the above example, the first data signal indicating the loss in balance sheet of the entity may be causal of the second data signal indicating some news regarding layoffs of its employees. As a result, both these data signals may form a casual pattern. With reference to FIG. 1, this casual pattern may be identified by the trained AI model based on the relation determined between each of these two data signals.

Referring now to FIG. 5, a flowchart of a method 500 of selecting an event is illustrated, in accordance with some embodiments. With reference to FIG. 4, upon identifying the pattern as mentioned via step 406, at step 502, one or more events mapped to the pattern may be identified. In continuation to above example, where the causal pattern is identified to have been existing between the first data signal (i.e., the loss in balance sheet of the entity) and the second data signal (i.e., some news regarding layoffs of its employees), then the one or more events identified based on the pattern may be, a fall in the stock price of the entity, a fall in the stock price of subsidiary of the entity, a fall in stock prices of suppliers of the entity, and the like.

Once the one or more events mapped to the pattern is identified, then at step 504, at least one event from the one or more events occurred within the predefined time period may be determined. In continuation to above example, suppose the at least one event that may occur within the pre-defined time period (for example: 15 days) may be, the fall in the stock price of the entity, and the fall in the stock price of subsidiary of the entity.

Upon determining at least one event, at step 506, a degree of confidence for each of the at least one event may be computed. In an embodiment, the degree of confidence associated with each of the at least one event may be computed based on a set of secondary attributes. In an embodiment, the set of secondary attributes may include, but is not limited to, a day of occurrence of each of the at least one event, a month of occurrence of each of the at least one event, a time of occurrence of each of the at least one event, and an end objective associated with an analysis of the plurality of data signals. In continuation to above example, the degree of confidence for an event, i.e., the fall in the stock price of the entity may be computed to be 95%. Further, the degree of confidence for an event, i.e., the fall in the stock price of the subsidiary of the entity may be computed to be 70%.

Once the degree of confidence associated with each of the at least one event is determined, then at step 508, an event may be selected from each of the at least one event based on an associated degree of confidence. As will be appreciated, the degree of confidence associated with the selected event may be highest among the degree of confidence determined for other events of each of the at least one event. For example, the event ‘the fall in the stock price of the entity’ may be selected as the degree of confidence computed for this event is 95%. With reference to FIG. 2, the selected event may correspond to the event whose occurrence was determined by the trained AI model within the pre-defined time period as mentioned via the step 208.

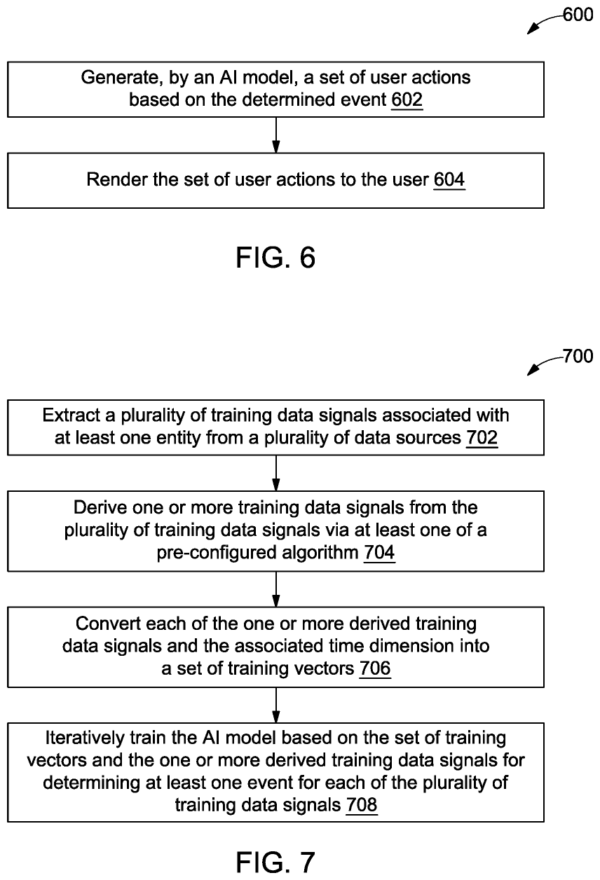

Referring now to FIG. 6, a flowchart of a method 600 for rendering a set of actions to a user is illustrated, in accordance with some embodiments. With reference to FIG. 2, once the occurrence of the event is determined, then at step 602, a set of user actions may be generated based on the determined event. In an embodiment, each of the set of user actions may correspond to a recommendation. By way of an example, when the plurality of data signals are trade signals and the determined event was a comment made a renowned personality on an application owned by the company (i.e., the entity), then the set of user actions may be a recommendation to buy a stock of the company, a recommendation to sell the stock of the company, a recommendation to hold a sell of previous purchased stock, and the like.

In continuation to above example, when the occurrence of the event ‘the fall in the stock prices of the entity’ was determined, then a set of user actions (i.e., recommendation), such as, to sell the stock of the entity, or sell the stock of the subsidiary of the entity may be generated. Once the set of user actions is generated, then at step 604, each of the set of user actions may be rendered to the user. Further, based on the rendered set of user actions, the user may accordingly take a suitable action corresponding to the stock of that company.

Referring now to FIG. 7, a flowchart of a method 700 of training an AI model for determining occurrence of events is illustrated, in accordance with some embodiments. In order to train the AI model for determining occurrence of an event, initially, at step 702, a plurality of training data signals may be extracted. Each of the plurality of extracted data signals may be associated with at least one entity. Further, the plurality of data signals may be extracted from a plurality of data sources. In an embodiment, the plurality of training data signals may include structured training data signals and unstructured training data signals. In addition, each of the plurality of training data signals may be extracted from the plurality of data sources for a pre-defined time period. By way of an example, the plurality of training data signals may correspond to trade signals. Examples of the plurality of training data signals may include, but is not limited to, historical trade data such as time-series data, price point data, trade volume, trade volatility, trade product, trade sector, trade market, trade related news, trade related blogs. The trade signals may be extracted for the plurality of entities from the plurality of data sources for the pre-defined time period, for example, say for past ‘6 years’, from 2015 to 2021 from the plurality of data sources. Examples of the plurality of data sources may include, but are not limited to, historical trade data sources, trade maps, trade trends, social media contents, and any other trade related data available in public and/or private domain. Further, each of the plurality of entities may correspond to an organization or a company.

Once the plurality of training data signals is extracted, then at step 704, one or more training data signals may be derived from the plurality of training data signals. In an embodiment, the one or more training data signals may be derived via at least one of a pre-configured algorithm, a statistical analysis technique, or an AI based analysis technique. In an embodiment, each of the one or more training data signals may include an associated time dimension. In an embodiment, the associated time dimension may represent a time period for which each of the one or more data signals may be valid. Upon deriving the one or more data signals, at step 706, each of the one or more derived training data signals and the associated time dimension may be converted into a set of training vectors.

Further, at step 708, an AI model may be trained based on the set of training vectors and the one or more derived training data signals for determining occurrence of one or more events for each of the plurality of training data signals. As will be appreciated, in some embodiments, the AI model may be trained for each entity individually. Moreover, in some other embodiments, the AI model may be trained for a group of entities, such that one or more attributes of the group of entities are common. The one or more attributes, for example, may include, but are not limited to, country, state, market cap, sector, customer base, and the like.

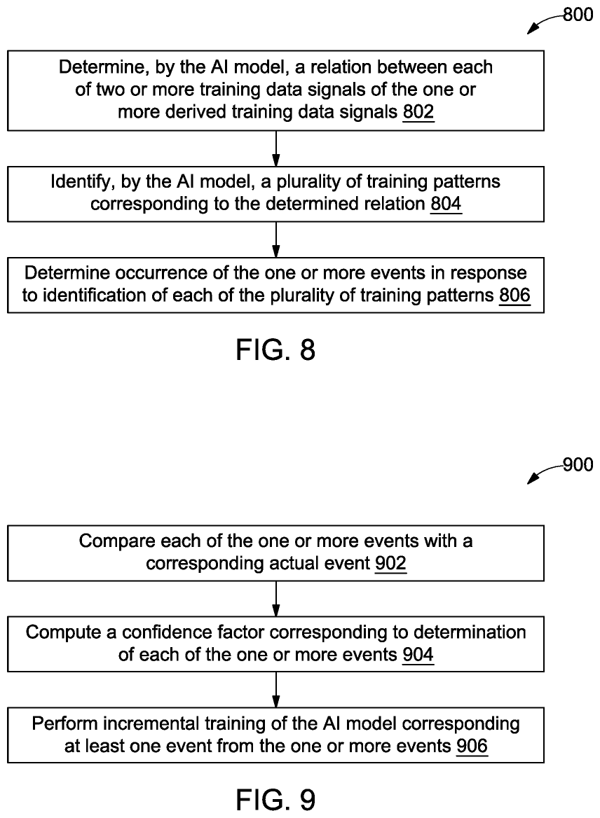

Referring now to FIG. 8, a flowchart of a method 800 for determining occurrence of one or more events is illustrated, in accordance with some embodiments. With reference to FIG. 7, in order to train the AI model for determining the occurrence of the one or more events, as mentioned via step 708, initially, at step 802, a relation between each of two or more training data signals of the one or more derived training data signals may be determined. In an embodiment, the relation between each of the two or more training data signals may be determined based on a vector associated with each of the two or more training data signals. In addition, the relation between the two or more training data signals may be determined based on at least one of a repeated occurrence of the two or more training data signals over a period of time, an interdependency between each of the two or more training data signals, and a co-occurrence between the two or more training data signals.

Once the relation between the two or more training data signals is determined, then at step 804, a plurality of training patterns corresponding to the determined relation may be identified. In an embodiment, each of the plurality of training patterns may correspond to occurrence of the two or more training data signals within an overlap in the time dimensions associated with the two or more training data signals. Upon identifying the plurality of patterns, at step 806, occurrence of the one or more events may be determined in response to identification of each of the plurality of training patterns.

Referring now to FIG. 9, a flowchart of a method 900 of performing incremental training of an AI model is illustrated, in accordance with some embodiments. With reference to FIG. 8, once the plurality of patterns is identified as mentioned via step 806, then at step 902, each of the one or more events may be compared with a corresponding actual event. Further, based on the comparison, at step 904, a confidence factor may be computed corresponding to determination of each of the one or more events, based on a pre-defined accuracy threshold in response to comparing. Upon computing the confidence score, at step 906, an incremental training of the AI model may be performed corresponding to at least one event from the one or more events. In an embodiment, the confidence factor of the at least one event may be below the pre-defined accuracy threshold.

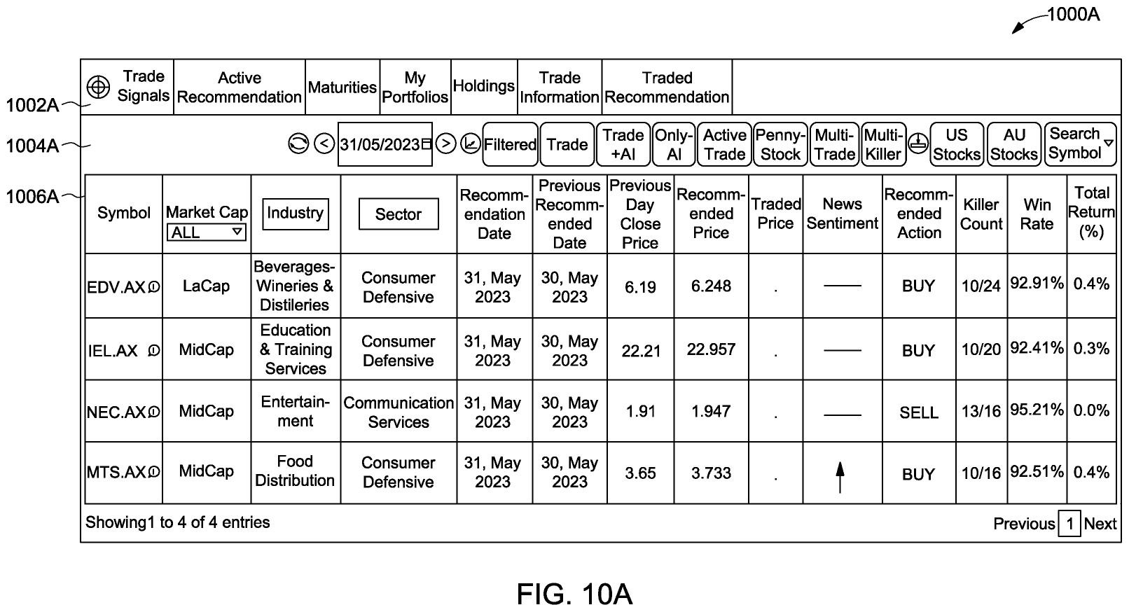

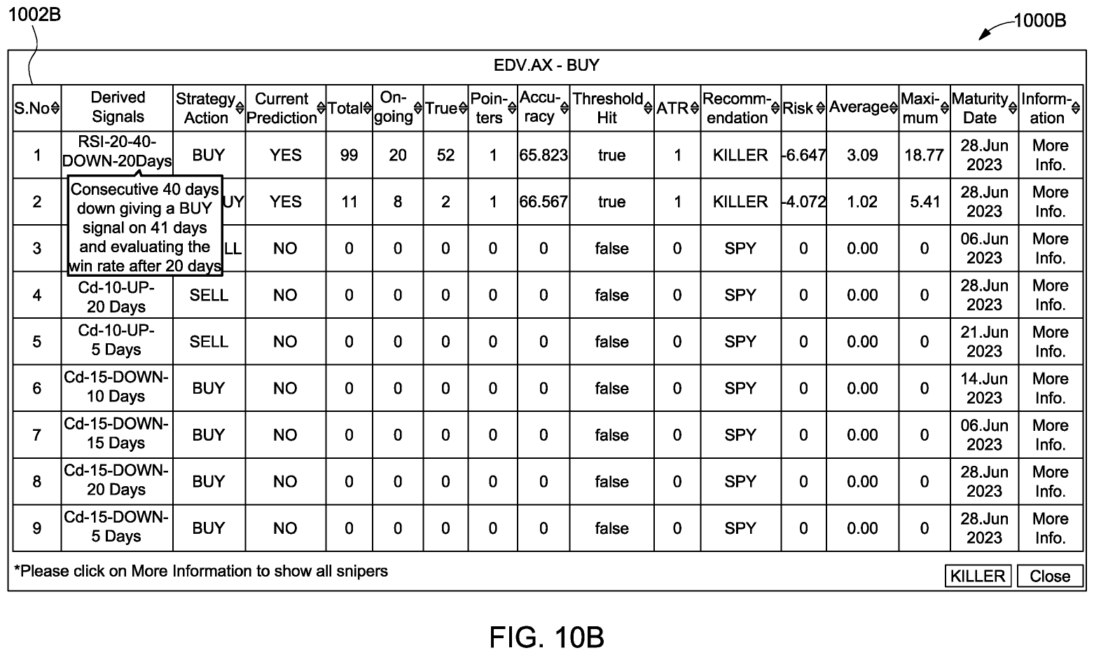

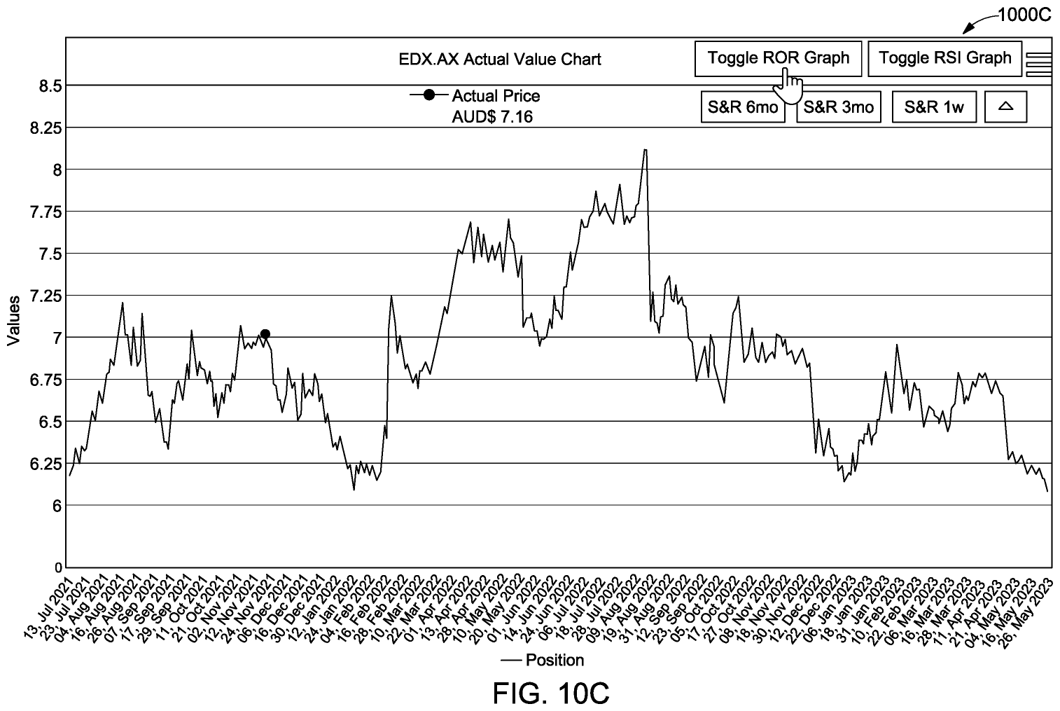

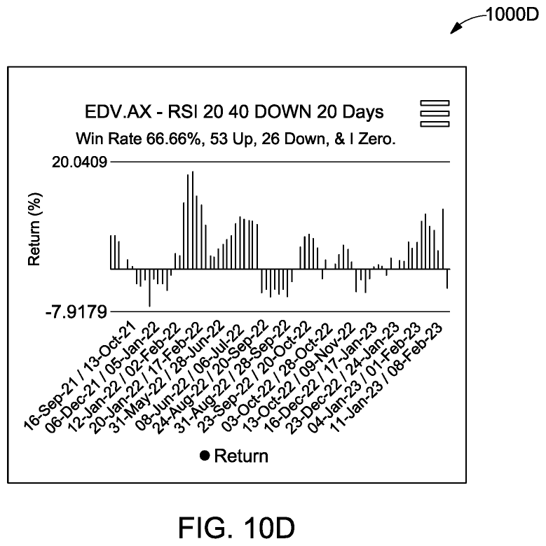

Referring now to FIG. 10A-10D, represents GUIs depicting determination of occurrence of an event associated with an entity, in accordance with an exemplary embodiment. FIGS. 10A-10D are explained in conjunction with FIGS. 1-9. With reference to FIGS. 7-9, once the AI model is trained, the trained AI model may be used by the user for determining occurrence of the event associated with the entity. With reference to FIG. 1, initially in order to determine the occurrence of the event corresponding to an entity of the set of entities, the user (e.g., a trader) may open the application (e.g., a web application or a mobile application) installed within the electronic device 102. As will be appreciated, the application may be installed within the memory 104 of the electronic device 102. In some embodiment, the application may be installed within the user device. Further, the application may be configured to communicate to the trained AI model to determine the occurrence of the event corresponding to the entity.

In FIG. 10A, a set of trade signals associated with a set of four entities is illustrated via a GUI 1000A. In an embodiment, each of the set of four entities may be one of a company or an organization. As depicted via the GUI 100A, the set of four entities may include ‘an Endeavour Group Limited (EDV.AX)’, ‘an IDP Education Limited (IEL.AX)’, ‘a Nine Entertainment Co. Holdings Ltd (NEC.AX)’, and ‘a Metcash Limited (MTE.AX)’. In the GUI 1000A, a first row 1002A may represent a menu bar. The menu bar may include a set of options. As depicted via the GUI 1000A, the set of options may be ‘trade signals’, ‘active recommendations’, ‘maturities’, ‘my portfolios’, ‘holdings’, ‘sniper information’, and ‘traded recommendations’. The user may select a suitable option from the set of options based on his requirement. By way of an example, when the user may select an option ‘trade signals’, then the set of trade signals associated with the set of four entities may be rendered to the user, as depicted via the GUI 1000A.

Further, a second row 1004A may include a set of options for enabling the user to perform one or more tasks. For example, the user may select a suitable option for performing the one or more tasks, such as, the user may select an appropriated date from a calendar available within ‘a date option’ present in the second row 1004A based on his requirement, i.e., the date for which the user may be interested in viewing a trade signal of an entity from the set of four entities. The user may reset the selected date using the reset button present before ‘the date option’. Further, the user may traverse between dates using ‘<’ and ‘>’ options present on both adjacent sides of ‘the date option’. Apart from these options in the second row 1004A, the second row 1004A may include other options, such as, an option for providing graphical representation of the trade signals associated with each entities, ‘a filter option’ for selecting a required entity, ‘trade option’, ‘a trade+AI option’, ‘an only AI option’, ‘an active stock’, ‘a penny stock option’, ‘a multi-trade option’, ‘a multi-killer option’, ‘a download option next to the multi-killer option’, ‘a United States (US) stocks option’, ‘an Australia (AU) stocks option’, and ‘a search symbol option’.

Further, based on one or more options selected from the second row 1004A, relevant information corresponding to the set of trade signals may be rendered to the user in tabular form, as depicted via a third row 1006A of the GUI 1000A. In the GUI 1000A, each row of a first column, i.e., ‘symbol’ may represent a symbol associated with each of the set of four entities, such as, ‘EDV.AX’, ‘IEL.AX’, ‘NEC.AX’, and ‘MTS.AX’ respectively. Each row of a second column, i.e., ‘market cap’ may represent market capitalization of each of the set of four entities. As will be appreciated, market capitalization may refer to the total dollar market value of a company's outstanding shares of stock. The Market Cap may include a drop downlist via which the user can select the required number of entities for which the user may be interested in viewing the relevant information.

Each row of a third column, i.e., ‘industry’ may represent an Industry associated with each of the set of four entities. For example, the Endeavour Group Limited represented by the symbol ‘EDV.AX’ may belong to the industry ‘Beverages—Wineries and Distilleries’. By way of another example, the IDP Education Limited represented by the symbol ‘IEL.AX’ may belong to the industry ‘Education and Training Services’. In a similar manner, third and fourth row of the third column may represent an industry associated with the company the Nine Entertainment Co. Holdings Ltd, and the Metcash Limited, respectively. Further, each row of a fourth column, ‘sector’ may represent a sector to which each of the set of four entities may belong to. For example, as represented via the GUI 1000A, the EDV.AX, the IEL.AX, and the MTE.AX may belong to ‘consumer defensive’ sector. By way of another example, the NEC.AX may belong to ‘communication services’ sector.

Further, each row of a fifth column, i.e., ‘recommendation date’ may represent a current date or a future date for which the user may be interested in viewing a recommendation (i.e., a user action) for each of the set of four entities based on current trade signals associated with an entity of the set of four entities. Further, each row of a sixth column, i.e., ‘previous recommendation date’ may represent a previous recent date on which the recommendation was made for a stock associated with each of the set of four entities. Further, each row of a seventh column, i.e., ‘previous day close price’ may represent a previous day closing price (i.e., a security closing price) of the stock associated with each entity at an end of the day.

Further, each row of an eight column, i.e., ‘recommended price’ may represent a price recommended to buy or sell shares of the stock associated with each entity. Further, each row of a ninth column, i.e., ‘traded price’ may represent a most recent price of the stock associated with the entity on which a buyer or a seller may have agreed to trade. In the current GUI 1000A, the trading price is not shown for any of the set of four entities. Further, each row of a tenth column, i.e., ‘news sentiment’ may represent negative impact or positive impact of news or blogs associated with the entity. By way of an example, as depicted via the GUI 1000A, a news or a blog published for the fourth entity, i.e., the Metcash Limited may have a positive impact on that entity due to which the stock price of the Metcash Limited might have risen.

Further, each row of an eleventh column, i.e., ‘recommended action’ may represent the user action that is recommended to the user to buy or sell shares of the stock associated with the entity. For example, for the entity ‘the Endeavour Group Limited’, ‘the IDP Education Limited’, and ‘the Metcash Limited’, the user action recommended to the user may be ‘a buy’. By way of another example, for the entity the Nine Entertainment Co. Holdings Ltd, the user action recommended may be ‘a sell’.

Further, each row of a twelfth column, i.e., ‘killer count’ may represent a number of times the recommended action has been true for the shares of the stocks associated with the entity from a maximum number of times the recommended action was determined for that entity. Further, each row of a thirteenth column, i.e., ‘win rate’ may represent the win rate associated with the stock of the entity. The win rate may be a metric that indicates how profitable the user (i.e., the trader) might be, if the user performs the recommended action corresponding to the shares of the stock associated with the entity. Further, each row of a fourteenth column, i.e., ‘total returns (%)’ may represent an amount of value (in percentage) that the trader might earn, if the trader may perform the recommended action.

In FIG. 10B, the one or more data signals derived from the plurality of data signals associated with the entity ‘the Endeavour Group Limited’ represented by the symbol ‘EDV.AX’ is depicted via a GUI 1000B. In the GUI 1000B, each row of the first column, i.e., ‘S. No.’ may represent a serial number associated with each of the one or signals derived for the entity. Further, each row of a second column, i.e., ‘derived signal name’ may represent name of each of the one or more derived signals. As will be appreciated, for ease of explanation, nine derived signals are represented via the GUI 1000B. Further, each of the one or more signals may be derived via at least one of the pre-configured algorithm, the statistical analysis technique, or the AI based analysis technique.

Moreover, as depicted via the GUI 1000B, each of the one or more data signals may include an associated time dimension. By way of an example, for a first derived signals, i.e., Relative Strength Index (RSI)-20_40-down-20-days, where ‘20 days’ represents a time dimension associated with the first derived signals. For example, upon clicking on the first derived signal, an information regarding the first derived signal may be represented to the user via a highlighted pop-up window in the GUI 1000B. As depicted via the GUI 1000B, the information may be ‘consecutive 40 days down giving a buy signal on 41 days and evaluating the win rate after 20 days’.

Further, each row of a third column, i.e., ‘strategy action’ may represent the user action, i.e., an action that the user can perform corresponding to the stock of the EDV.AX, based on analysis of each of the nine derived signals. By way of an example, based on the analysis of the first derived signal, the action recommended to the user was to buy the stock of the entity ‘EDV.AX’. Further, each row of a fourth column, i.e., ‘current prediction’ may represent whether a prediction made for the stock of the “EDV.AX, based on each derived signal is the current prediction or not. For example, for the first derived signal, the prediction made is the current prediction. Whereas, for a fourth derived signal, i.e., CD-10-UP-20 days, the prediction made is not the current prediction.

Further, each row of a fifth column, i.e., ‘total occurrences’, may represent total number of occurrences of each of the nine derived signals. Further, each row of a sixth column, i.e., ‘ongoing occurrences’, may represent occurrences of each of the nine derived signals that continue to exist (or currently existing). Further, each row of a seventh column, i.e., ‘true occurrences’, may represent a number of times each of the nine derived signals may have actually occurred. For example, as depicted via the GUI 1000B for the first derived signal, the total occurrences are ‘99’, the ongoing occurrences are ‘20’, and the true occurrences are ‘52’.

Further, each row of an eighth column, i.e., ‘pointers’, may represent a change in value of the stock determined based on each of the nine derived signals. For example, based on the first derived signal, the change in value of the stock of the entity ‘EDV.AX’ is determined to be ‘1’ point, i.e., ‘0.01%’. Further, each row of a ninth column, i.e., ‘accuracy’ may represent an accuracy of each of the nine derived signals. For example, for the first derived signal, since the number of true occurrences of the first derived signal is ‘52’ and the total number of occurrences is ‘99’, therefore the first derived signal might have occurred 52 times out of 99 times, hence the accuracy of the first derived signal is determined to be ‘65.823%’.

Further, each row of a tenth column, i.e., ‘threshold hit’ may represent whether each of the nine derived signals may have crossed the pre-defined threshold limit. In other words, ‘the threshold hit’ may represent whether the accuracy determined for each of the nine derived signals is above than the pre-defined threshold limit. In an embodiment, when the accuracy determined for a signal of the nine derived signals is determined to be above than the pre-defined threshold limit, then for that signal, the threshold hit may be marked as true. In another embodiment, when the accuracy determined for a signal of the nine derived signals is determined to be below than the pre-defined threshold limit, then for that signal, the threshold hit may be marked as false. For example, suppose the pre-defined threshold limit was defined to be 60%. In this case, since for the first derived signal, the accuracy calculated was ‘65.823%’, which is above the pre-defined threshold limit, hence the threshold hit for the first derived signal was determined to be true.

Further, each row of an eleventh column, i.e., ‘ATR’ may represent average true range predicted for the stock of the entity ‘EDV.AX’ based on each of the nine derived signals to measure volatility of market based on range and price movement of the market. Further, each row of a twelfth column, i.e., ‘recommendation’ may represent whether a signal of the nine derived signals is good signal or a bad signal. In an embodiment, when the accuracy determined for a signal of the nine derived signals is determined to be above than the pre-defined threshold limit and the threshold hit is true, then that signal may be determined to be the good signal and the recommendation for that signal may be made as ‘killer’ signal. In another embodiment, when the accuracy determined for a signal of the nine derived signals is determined to be below than the pre-defined threshold limit and the threshold hit is false, then that signal may be determined to be the bad signal, the recommendation for that signal may be made as ‘spy’ signal.

Further, each row of a thirteenth column, i.e., ‘risk’ may represent a percentage of risk determined based on each of the nine derived signals. The percentage of risk may enable the user to see the risk involved in purchasing the stock of the entity ‘EDV.AX’. For example, based on the first derived signal, the percentage of risk determined in purchasing of the stock is ‘−6.647%’. Further, each row of a fourteenth column, i.e., ‘average’ may represent an average purchase benefit calculated based on each of the nine derived signals. The average purchase benefit may depict the benefit (or return) that the user may get on purchase of the stock of the entity ‘EDV.AX’.

Further, each row of a fifteenth column, i.e., ‘maximum’ may represent maximum purchase benefit calculated based on each of the nine derived signals. The maximum purchase benefit may depict, the maximum benefit (or return) that the user may get on purchase of the stock of the entity ‘EDV.AX’. Further, each row of a sixteenth column, i.e., ‘maturity date’ may represent a last transaction date determined for the purchase or sale of the stock of the entity “EDV.AX. Further, each row of a seventeenth column, i.e., ‘information’ may include a click button, i.e., ‘more info.’. By clicking on ‘the more info.’ button, the user may be able to see more information (historical and future) about that derived signals to decide whether to purchase the stock of the entity ‘EDV.AX’ or not. As will be appreciated, each of the nine derived signals may be used by the AI model (same as the trained AI model) to identify the pattern associated with the entity ‘EDV.AX’. Further, based on the identified pattern, the occurrence of the event (such as, buy or sell) associated with the entity ‘EDV.AX’ may be determined. In addition to the, the GUI 1000B may include two clickable buttons, i.e., ‘KILLER’ and ‘CLOSE’. The user may use the ‘KILLER’ button to see all derived signals that are good signals and provide the buy recommendation for the stock of the entity EDV.AX. Further, the user may use ‘CLOSE’ button to close the GUI 1000B.

In FIG. 10C, a graphical representation of an actual value chart generated for the entity “EDV.AX’ based on the first derived signal is depicted via a GUI 1000C. An ‘X-axis’, of a graph 1002C represents positions of the stock price at each date. In other words, the position may represent whether the stock price for the entity ‘EDV.AX’ was up or down based on the first derived signal. Further, ‘Y-axis’ may represent values of the stock of the entity ‘EDV.AX’ at each date. In an embodiment, the ‘Y-axis’ represents a value of the stock that the user may be willing to pay on each date. By way of an example, as represented via a dot, on the date ‘24^{th}. Nov. 2021’, an Australian Dollar (AUD) price for the stock of the entity EDV.AX was determined to be 7.16$. Further, the user can view the actual value chart for the entity EDV.AX of 6 months, 3 months, 1 week, and the like, by selecting a suitable option present on top in right side of the GUI 1000C. In addition, the user may be able to see a Rate of Return (ROR) graph or a Relative Strength Index (RSI) graph by clinking on a respective button, i.e., toggle ROR graph or toggle RSI graph present on top in right side of the GUI 1000C.

In FIG. 10D, a graphical representation of the ROR graph is depicted via a GUI 1000D. In other words, a return that may be generated based on the analysis of the first derived signal on purchase of the stock of the entity ‘EDV.AX’ is depicted via the GUI 1000D. In the GUI 1000D, on a top portion of the ROR graph, a first row of the ROR graph represents the entity name, i.e., ‘EDV.AX’ and name of the first derived signal, i.e., ‘RSI-20-40-down-20 days’. Further, a second row represents a win rate in percentage. The win rate is a measurement of the amount of success that the user may generate over a certain period. For example, as depicted via the GUI 1000D, the win rate determined for the stock of the entity ‘EDV.AX’ based on the first derived signal may be 66.667%. In addition, the second row may represent, number of times the stock price of the entity was up or down based on analysis of the first derived signal. For example, based on the first derived signal, the stock price was up for 52 times, and down for 26 times. In addition, zero percentage of increase or decrease in the stock prices was noted for 1 time.

Further, X-axis may represent dates depicting an amount of increase or decrease in the return that may be generated on purchase of the stock of the entity ‘EDV.AX’ on a particular date. Further, Y-axis may represent the return in percentage on each date represented via the X-axis. Based on analysis of the first derived signal, a detailed summary may be generated for enabling the user to understand the return on purchase of the stock of the entity ‘EDV.AX’. The detailed summary may include the user action (i.e., the recommendation), e.g., buy or sell. By way of an example, the detailed summary may be, for example, ‘current prediction ‘buy’ which gives the killer strategy based on the RSI-20-40-down-20 days, this indicates a buy opportunity for the stock of the entity ‘EDV.AX’. EDV.AX showed an undefined expectancy due to (56 up and 26 down) and the win rate of 65.823%. In this latest scenario in 2023 year, the RSI-20-40-down-20 days, buy is suggested with an average return of −3.432% at close price of Australian dollar (AUD) 6.41 on 3 May 2023 and close price of AUD 6.19 on 30 May 2023. Further, using the displayed detailed summary, the user may buy or sell the stock (or the shares of the stock) associated with the entity. As will be appreciated, the detailed summary may be generated by the trained AI model.

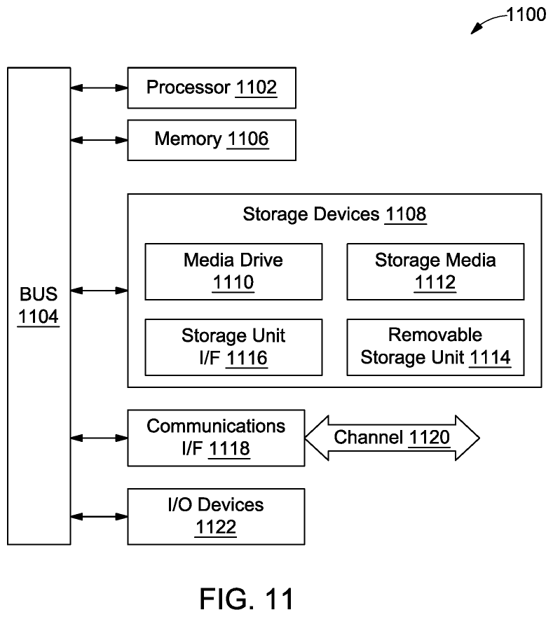

The disclosed methods and systems may be implemented on a conventional or a general-purpose computer system, such as a personal computer (PC) or server computer. Referring now to FIG. 11, an exemplary computing system 1100 that may be employed to implement processing functionality for various embodiments such as a SIMD device, client device, server device, one or more processors, or the like has been illustrated. Those skilled in the relevant art will also recognize how to implement the invention using other computer systems or architectures. The computing system 1100 may represent, for example, a user device such as a desktop, a laptop, a mobile phone, personal entertainment device, DVR, and so on, or any other type of special or general-purpose computing device as may be desirable or appropriate for a given application or environment.

The computing system 1100 may include one or more processors, such as a processor 1102 that may be implemented using a general or special purpose processing engine such as, for example, a microprocessor, microcontroller, or other control logic. In this example, the processor 1102 is connected to a bus 1104 or other communication medium. In some embodiments, the processor 1102 may be an Artificial Intelligence (AI) processor, which may be implemented as a Tensor Processing Unit (TPU), or a graphical processor unit, or a custom programmable solution Field-Programmable Gate Array (FPGA).

The computing system 1100 may also include a memory 1106 (main memory), for example, Random Access Memory (RAM) or other dynamic memory, for storing information and instructions to be executed by the processor 1102. The memory 1106 also may be used for storing temporary variables or other intermediate information during execution of instructions to be executed by the processor 1102. The computing system 1100 may likewise include a read only memory (“ROM”) or other static storage device coupled to bus 1104 for storing static information and instructions for the processor 1102.

The computing system 1100 may also include a storage device 1108, which may include, for example, a media drive 1110 and a removable storage interface. The media drive 1110 may include a drive or other mechanism to support fixed or removable storage media, such as a hard disk drive, a floppy disk drive, a magnetic tape drive, an SD card port, a USB port, a micro-USB, an optical disk drive, a CD or DVD drive (R or RW), or other removable or fixed media drive. A storage media 1112 may include, for example, a hard disk, magnetic tape, flash drive, or other fixed or removable medium that is read by and written to by the media drive 1110. As these examples illustrate, the storage media 1112 may include a computer-readable storage medium having stored there in particular computer software or data.

In alternative embodiments, the storage devices 1108 may include other similar instrumentalities for allowing computer programs or other instructions or data to be loaded into the computing system 1100. Such instrumentalities may include, for example, a removable storage unit 1114 and a storage unit interface 1116, such as a program cartridge and cartridge interface, a removable memory for example, a flash memory or other removable memory module, and memory slot, and other removable storage units and interfaces that allow software and data to be transferred from the removable storage unit 1114 to the computing system 1100.

The computing system 1100 may also include a communications interface 1118. The communications interface 1118 may be used to allow software and data to be transferred between the computing system 1100 and external devices. Examples of the communications interface 1118 may include a network interface such as an Ethernet or other NIC card, a communications port such as a USB port, a micro-USB port, Near Field Communication (NFC), and the like. Software and data transferred via the communications interface 1118 may be in the form of signals which may be electronic, electromagnetic, optical, or other signals capable of being received by the communications interface 1118. These signals are provided to the communications interface 1118 via a channel 1120. The channel 1120 may carry signals and may be implemented using a wireless medium, wire or cable, fiber optics, or another communications medium. Some examples of the channel 1120 may include a phone line, a cellular phone link, an RF link, a Bluetooth link, a network interface, a local or wide area network, and other communications channels.

The computing system 1100 may further include Input/Output (I/O) devices 1122. Examples may include, but are not limited to a display, keypad, microphone, audio speakers, vibrating motor, LED lights, etc. The I/O devices 1122 may receive input from a user and display an output of the computation performed by the processor 1102. In this document, the terms “computer program product” and “computer-readable medium” may be used generally to refer to media such as, for example, the memory 1106, the storage devices 1108, the removable storage unit 1114, or signal(s) on the channel 1120. These and other forms of computer-readable media may be involved in providing one or more sequences of one or more instructions to the processor 1102 for execution. Such instructions, generally referred to as “computer program code” which may be grouped in the form of computer programs or other groupings, when executed, enable the computing system 1100 to perform features or functions of embodiments of the present invention.

In an embodiment where the elements are implemented using software, the software may be stored in a computer-readable medium and loaded into the computing system 1100 using, for example, the removable storage unit 1114, the media drive 1110 or the communications interface 1118. The control logic may for example include software instructions or computer program code, when executed by the processor 1102, and the like, cause the processor 1102 to perform the functions of the invention as described herein.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., are non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only.

What is claimed is:

1. A method for determining occurrence of events based on data signals, the method comprising:
receiving a plurality of data signals associated with an entity from a plurality of data sources, wherein the plurality of data signals comprises structured data signals and unstructured data signals;
deriving one or more data signals from the plurality of data signals via at least one of a pre-configured algorithm, a statistical analysis technique, or an Artificial Intelligence (AI) based analysis technique, wherein each of the one or more data signals comprises an associated time dimension;
identifying, by a trained AI model, a pattern associated with the entity within the one or more derived data signals and the plurality of data signals, wherein the pattern corresponds to occurrence of two or more data signals within an overlap in the time dimensions associated with the two or more data signals; and
determining, by the trained AI model, occurrence of an event associated with the entity within a predefined time period, based on the identified pattern and the overlap in the time dimensions associated with the two or more data signals.

2. The method of claim 1, further comprising:
pre-processing each of the plurality of data signals received from the plurality of data sources based on pre-defined criteria; and
removing a set of data signals from the plurality of data signals in response to pre-processing, wherein each of the set of data signals corresponds to a noisy data signal.

3. The method of claim 1, wherein identifying the pattern comprises:
converting each of the one or more data signals and the associated time dimension into a set of vectors;
determining, by the trained AI model, whether a relation exists between the two or more data signals from the one or more data signals based on a vector associated with each of the two or more data signals; and
upon determining the relation, identifying, by the trained AI model, the pattern corresponding to the determined relation.

4. The method of claim 3, wherein the relation is determined based on at least one of a repeated occurrence of the two or more data signals over a period of time, a magnitude of an analogous pattern associated with two or more former data signals, and a weight associated the analogous pattern.

5. The method of claim 3, further comprising:
upon identifying the pattern, identifying, by the trained AI model, one or more events mapped to the pattern;
determining, by the trained AI model, at least one event from the one or more events occurred within the predefined time period;
computing, by the trained AI model, a degree of confidence for each of the at least one event based on a set of secondary attributes; and
selecting, by the trained AI model, an event from each of the at least one event based on an associated degree of confidence.

6. The method of claim 1, further comprising:
generating, by an AI model, a set of user actions based on the determined event; and
rendering the set of user actions to the user.

7. A method of training an Artificial Intelligence (AI) model for determining occurrence of events, the method comprising:
extracting a plurality of training data signals associated with at least one entity from a plurality of data sources, wherein the plurality of training data signals comprises structured training data signals and unstructured training data signals, and wherein the plurality of training data signals is extracted from the plurality of data sources for a pre-defined time period;
deriving one or more training data signals from the plurality of training data signals via at least one of a pre-configured algorithm, a statistical analysis technique, or an Ai based analysis technique, wherein each of the one or more training data signals comprises an associated time dimension;
converting each of the one or more derived training data signals and the associated time dimension into a set of training vectors; and
iteratively training the AI model based on the set of training vectors and the one or more derived training data signals for determining occurrence of one or more events for each of the plurality of training data signals.

8. The method of claim 7, wherein training the AI model for determining the occurrence of the one or more events comprises:
determining, by the AI model, a relation between each of two or more training data signals of the one or more derived training data signals based on a vector associated with each of the two or more training data signals;
identifying, by the AI model, a plurality of training patterns corresponding to the determined relation, wherein each of the plurality of training patterns corresponds to occurrence of the two or more training data signals within an overlap in the time dimensions associated with the two or more training data signals; and
determining, by the AI model, occurrence of the one or more events in response to identification of each of the plurality of training patterns.

9. The method of claim 8, further comprising:
comparing each of the one or more events with a corresponding actual event;
computing a confidence factor corresponding to determination of each of the one or more events, based on a pre-defined accuracy threshold in response to comparing; and
performing incremental training of the AI model corresponding to at least one event from the one or more events, wherein the confidence factor of the at least one event is below the pre-defined accuracy threshold.

10. A system for determining occurrence of events based on data signals, the system comprising:
a processor; and
a memory communicatively coupled to the processor, wherein the memory stores processor-executable instructions, which, on execution, causes the processor to:
receive a plurality of data signals associated with an entity from a plurality of data sources, wherein the plurality of data signals comprises structured data signals and unstructured data signals;
derive one or more data signals from the plurality of data signals via at least one of a pre-configured algorithm, a statistical analysis technique, or an Artificial Intelligence (AI) based analysis technique, wherein each of the one or more derived data signals comprises an associated time dimension;
identify, by a trained AI model, a pattern associated with the entity within the one or more derived data signals and the plurality of data signals, wherein the pattern corresponds to occurrence of two or more data signals within an overlap in the time dimensions associated with the two or more data signals; and
determine, by the trained AI model, occurrence of an event associated with the entity within a predefined time period, based on the identified pattern and the overlap in the time dimensions associated with the two or more data signals.

11. The system of claim 10, wherein the processor executable instructions further cause the processor to:
pre-process each of the plurality of data signals received from the plurality of data sources based on pre-defined criteria; and
remove a set of data signals from the plurality of data signals in response to pre-processing, wherein each of the set of data signals corresponds to a noisy data signal.

12. The system of claim 10, wherein, to identify the pattern, the processor executable instructions further cause the processor to:
convert each of the one or more data signals and the associated time dimension into a set of vectors;
determine, by the trained AI model, whether a relation exists between the two or more data signals from the one or more data signals based on a vector associated with each of the two or more data signals; and
upon determining the relation, identify, by the trained AI model, the pattern corresponding to the determined relation.

13. The system of claim 12, wherein the relation is determined based on at least one of a repeated occurrence of the two or more data signals over a period of time, a magnitude of an analogous pattern associated with two or more former data signals, and a weight associated the analogous pattern.

14. The system of claim 12, wherein the processor executable instructions further cause the processor to:
upon identifying the pattern, identify, by the trained AI model, one or more events mapped to the pattern;
determine, by the trained AI model, at least one event from the one or more events occurred within the predefined time period;
compute, by the trained AI model, a degree of confidence for each of the at least one event based on a set of secondary attributes; and
select, by the trained AI model, an event from each of the at least one event based on an associated degree of confidence.

15. The system of claim 10, wherein the processor executable instructions further cause the processor to:
generate, by an AI model, a set of user actions based on the determined event; and
render the set of user actions to the user.

16. A system for training an Artificial Intelligence (AI) model for determining occurrence of events, the system comprising:
a processor; and
a memory communicatively coupled to the processor, wherein the memory stores processor-executable instructions, which, on execution, causes the processor to:
extract a plurality of training data signals associated with at least one entity from a plurality of data sources, wherein the plurality of training data signals comprises structured training data signals and unstructured training data signals, and wherein the plurality of training data signals is extracted from the plurality of data sources for a pre-defined time period;
derive one or more training data signals from the plurality of training data signals via at least one of a pre-configured algorithm, a statistical analysis technique, or an AI based analysis technique, wherein each of the one or more training data signals comprises an associated time dimension;
convert each of the one or more derived training data signals and the associated time dimension into a set of training vectors; and
iteratively train the AI model based on the set of training vectors and the one or more derived training data signals for determining occurrence of one or more events for each of the plurality of training data signals.

17. The system of claim 16, wherein, to train the AI model for determining the occurrence of the one or more events, the processor executable instructions further cause the processor to:
determine, by the AI model, a relation between each of two or more training data signals of the one or more derived training data signals based on a vector associated with each of the two or more training data signals;
identify, by the AI model, a plurality of training patterns corresponding to the determined relation, wherein each of the plurality of training patterns corresponds to occurrence of the two or more training data signals within an overlap in the time dimensions associated with the two or more training data signals; and
determine, by the AI model, occurrence of the one or more events in response to identification of each of the plurality of training patterns.

18. The system of claim 17, wherein the processor executable instructions further cause the processor to:
compare each of the one or more events with a corresponding actual event;
compute a confidence factor corresponding to determination of each of the one or more events, based on a pre-defined accuracy threshold in response to comparing; and
perform incremental training of the AI model corresponding to at least one event from the one or more events, wherein the confidence factor of the at least one event is below the pre-defined accuracy threshold.
